(19) United States
(12) Patent Application Publication
(10) Pub. No.: US 2010/0073592 A1
(43) Pub. Date: Mar. 25, 2010

(54) BACKLIGHT UNIT AND LIQUID CRYSTAL DISPLAY APPARATUS

(76) Inventor: Kentaro Kamada, Osaka (JP)

Correspondence Address: BIRCH STEWART KOLASCH & BIRCH, PO BOX 747, FALLS CHURCH, VA, 22040-0747, US

(21) Appl. No.: 12/525,455

(22) PCT Filed: Nov. 21, 2007
(86) PCT No.: PCT/JP2007/072521

§ 371 Date: Jul. 31, 2009

(30) Foreign Application Priority Data
Apr. 19, 2007 (JP) 2007-109998
Jun. 4, 2007 (JP) 2007-147594

(51) Int. Cl. G02F 1/1333; G09F 13/04

(52) U.S. Cl. 349/58; 362/97.1

(57) ABSTRACT

In a backlight unit (82) in which a diffusive plate (DL) through which light from fluorescent lamps (71) is passed is so supported by side holders (SF) as to be held, the side holders (SF) are made out of a metal.

### TECHNICAL FIELD

The present invention relates to a backlight unit that emits light, and to a liquid crystal display apparatus using light emitted from such a backlight unit.

### BACKGROUND ART

In a liquid crystal display apparatus such as a liquid crystal television receiver, a backlight unit feeding light to a liquid crystal display panel is mounted. Typically, such a backlight unit is provided with light sources, such as fluorescent lamps, each emitting light, and a diffusive member receiving and diffusing that light from the light sources, and then guiding it into a liquid crystal display panel.

In the case of a backlight unit as described above, there arise several problems owing to heat generated as the light sources emit light. For example, Patent Document 1 deals with a problem that a diffusive member suffers a rise in temperature owing to heat generated from the light sources, and that a liquid crystal display panel, provided above that diffusive member, thus suffers a rise in temperature (see paragraph [0006] of Patent Document 1). This problem undesirably leads to degraded quality of a display as a liquid crystal display apparatus.

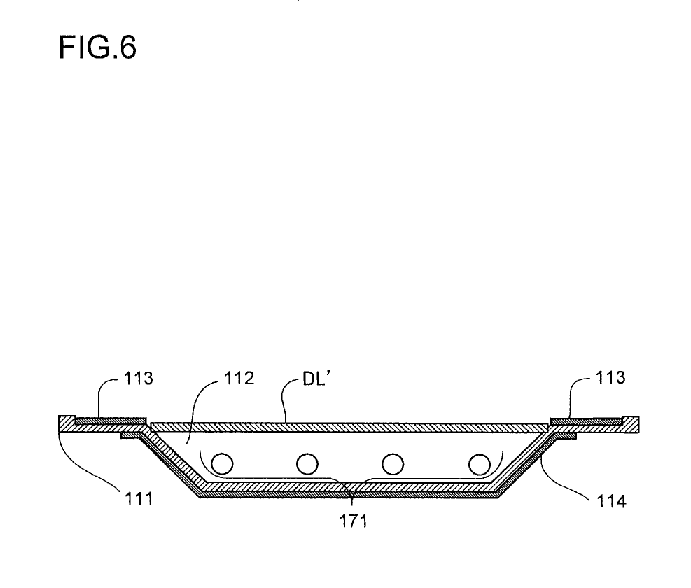

To solve this problem, as shown in FIG. 6, a backlight unit disclosed in patent document 1 is provided with thermally conductive members 113 and 114 at portions having no contact with a closed space 112 (space in which heat from a florescent lamp 171 is accumulated) which is enclosed by a dish-like member 111 directly supporting a liquid crystal display panel and a diffusive member DL′, namely at portions more easily exposed to air. Thus, heat accumulated in the dish-like member 111 having contact with the closed space 112 is dissipated; consequently, heat is less likely to conduct to the liquid crystal display panel.
Patent Document 1: JP-A-H06-67179 (see paragraphs [0006] and [0020])

### DISCLOSURE OF THE INVENTION

### Problems to be Solved by the Invention

However, apart from a rise in temperature inside the liquid crystal display, there is another factor inconveniently leading to degraded quality of a display shown by the liquid crystal display apparatus. That is, the diffusive member DL′ develops a warp owing to heat generated from the fluorescent lamp 171, When the diffusive member DL′ warps, there occurs nonuniformity, etc. in an amount of light emitted through the diffusive member DL′ (light from the backlight). However, in the liquid crystal display apparatus disclosed in Patent Document 1, heat carried by the diffusive member DL′ is not dissipated through the thermally conductive members 113 and 114.

In view of the above, the present invention is devised. And its object is to provide a backlight unit that can dissipate heat carried by a diffusive member, and a liquid crystal display apparatus equipped with such a backlight unit.

### Means for Solving the Problem

The present invention provides a backlight unit having a diffusive member through which light from a light source is passed held by a supporting frame; in particular, the supporting frame being made out of a metal.

The metal is a material having comparatively high heat-conductivity. Thus, when the supporting frames made out of such a metal hold the diffusive member, heat generated by the light source and carried by the diffusive member is absorbed through the supporting frames. This leads to the diffusive member less likely to develop a warp ascribable to heat. As a result, no degradation (unstabilized amount of light, etc.) owing to a warp developed in the diffusive member occurs to the light emitted through the diffusive member.

There is no particular restriction imposed on the kind of a metal out of which the supporting frame is made; for example, it may be made out of iron, aluminum or the like. In short, it may be made out of a metal having comparatively high heat-conductivity, suitable for absorbing heat carried by the diffusive member.

Preferably, the supporting frames and the diffusive member have surface-to-surface contact. Such contact leads to an increase in an area of contact between the two (supporting frame and diffusive member); consequently, heat carried by the diffusive member is efficiently absorbed.

Preferably, the supporting member is provided with a groove permitting the diffusive member to be sandwiched therebetween. Thus, the diffusive member is permitted to be fit into the grooves; thus, both front and back surfaces of the diffusive member are made to have contact with the supporting frames. Consequently, the area of contact between the supporting frames and the diffusive member is increased, with the result that heat carried by the diffusive member is efficiently absorbed.

The present invention encompasses a liquid crystal display apparatus including the backlight unit described above and a liquid crystal display panel receiving light from that backlight unit.

### ADVANTAGES OF THE INVENTION

A backlight unit of the present invention helps reduce the likeliness of a diffusive plate carrying heat ascribable to a light source. Accordingly, the diffusive plate is less likely to develop a warp ascribable to heat, and there hardly occurs degradation, owing to such a warp, to light from the backlight.

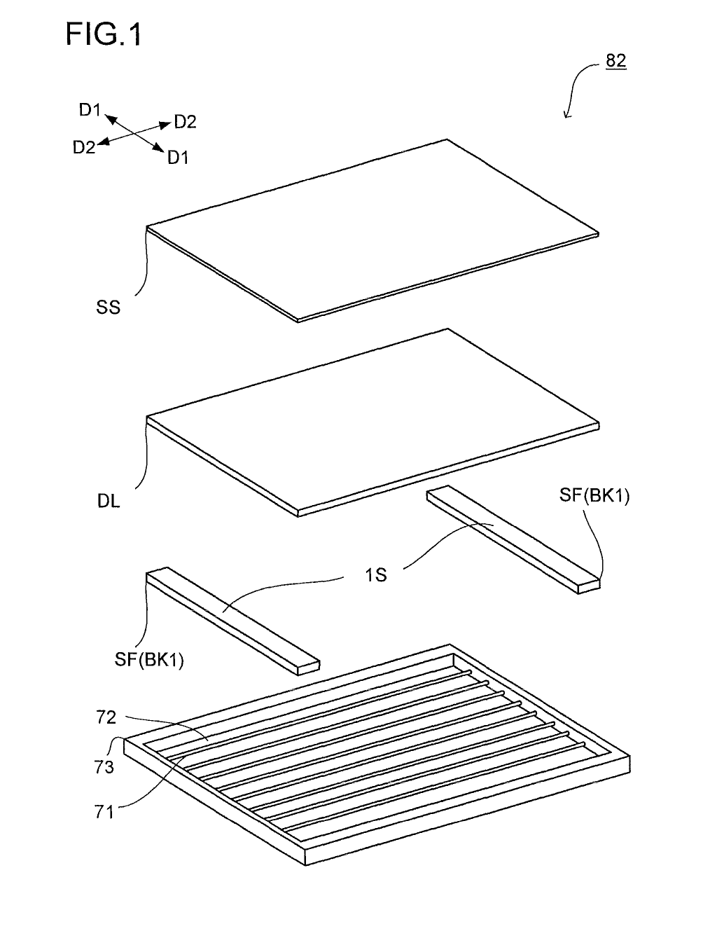

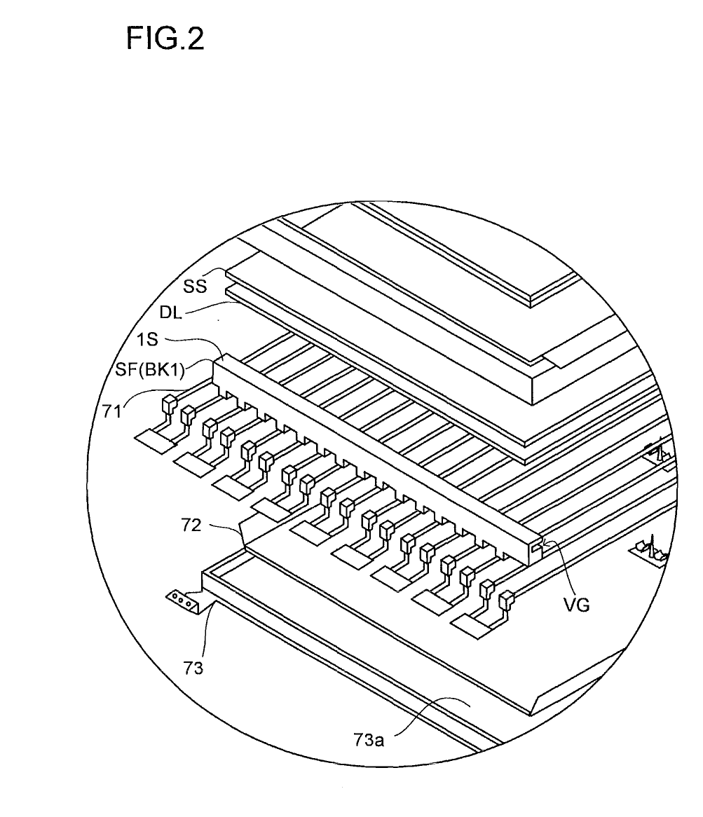

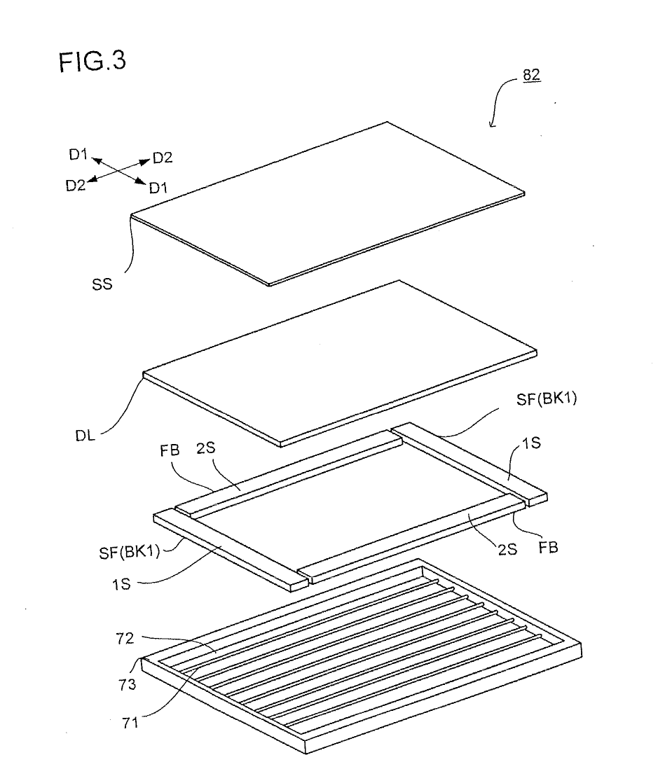

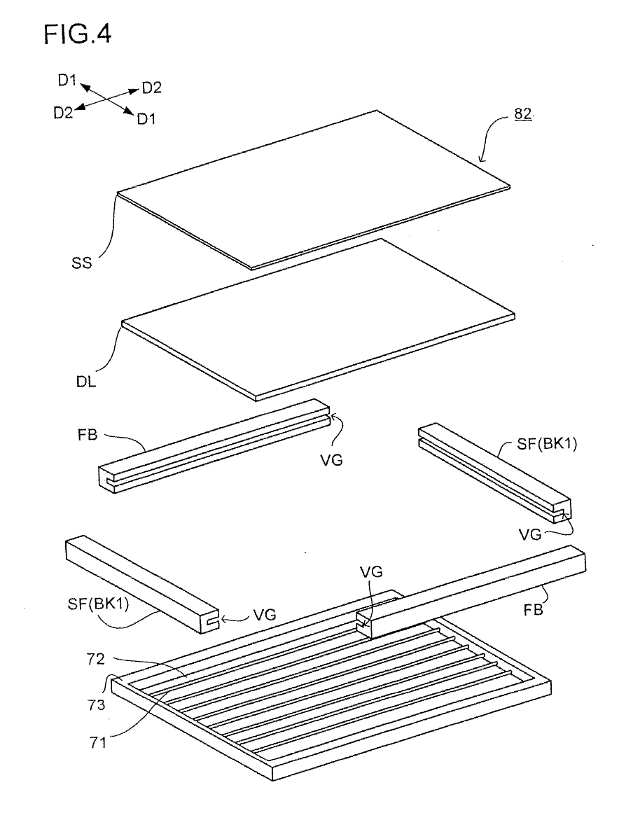

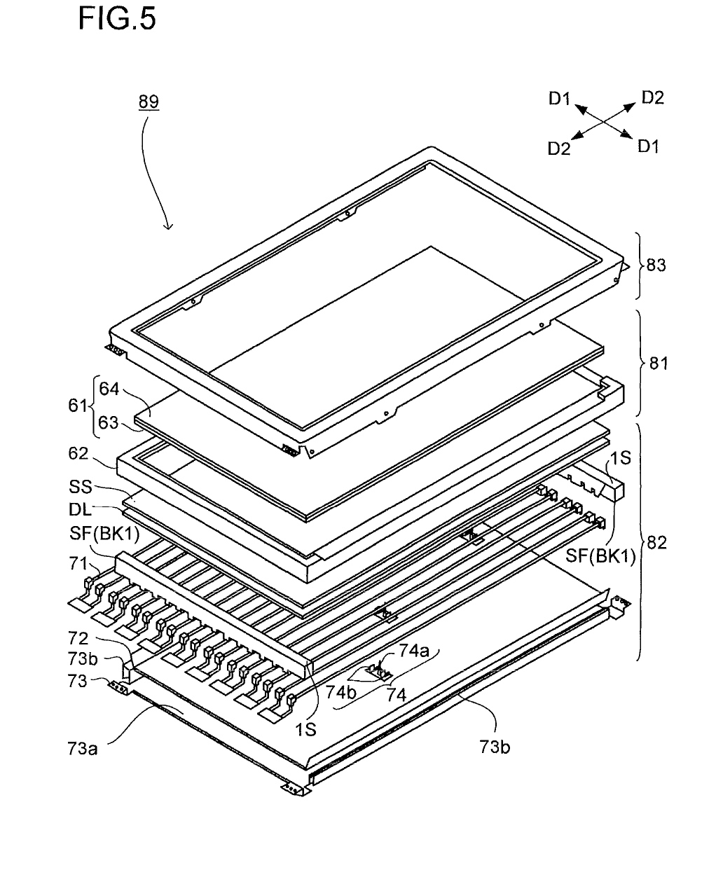

### BRIEF DESCRIPTION OF DRAWINGS

[FIG. 1] A perspective view schematically showing a backlight unit shown in FIG. 5;

[FIG. 2] A perspective view showing an example of a side holder;

[FIG. 3] A perspective view showing another example of the backlight unit shown in FIG. 1;

[FIG. 4] A perspective view showing yet another example of the backlight unit shown in FIGS. 1 and 3;

[FIG. 5] A perspective view of a backlight unit; and

[FIG. 6] A cross-sectional view of a conventional backlight unit.

### LIST OF REFERENCE SYMBOLS

SF Side holders (supporting frames)
BK1 First blocks (supporting frames)
1S Surfaces of the first blocks (supporting surfaces)
FB Supporting blocks (supporting frames)
VG Grooves
DL Diffusive plate (diffusive member)
SS Lens sheet
81 Liquid crystal display panel unit
82 Backlight unit
83 Bezel
89 Liquid crystal display apparatus

### BEST MODE FOR CARRYING OUT THE INVENTION

### Embodiment 1

Hereinafter, a first embodiment of the present invention will be described with reference to accompanying drawings. For the sake of convenience, reference numerals may be omitted; in that case, reference should be made to the other drawings.

FIG. 5 is an exploded perspective view of a liquid crystal display apparatus 89. FIG. 1 is a schematic perspective view mainly showing a side holders SF, a diffusive plate DL and the like, which will be described later. As shown in FIG. 5, the liquid crystal display apparatus 89 includes: a liquid crystal display panel unit 81; a backlight unit 82; and a bezel 83 covering outer edges of both units 81 and 82.

The liquid crystal display panel unit 81 includes a liquid crystal display panel 61, and a chassis (panel chassis) 62 formed into a frame and supporting an outer edge of the liquid crystal display panel 61.

The liquid crystal display panel 61 is formed such that an active matrix substrate (AM substrate) 63 and a counter substrate 64 facing that AM substrate 63 are bonded together with a seal member (unillustrated), and that liquid crystal (unillustrated) is injected in a space between these substrates. The liquid crystal display panel 61 includes an optical sheet (e.g., polarizing sheet, phase-difference sheet; unillustrated) sandwiching the AM substrate 63 and the counter substrate 64.

And the liquid crystal display panel 61 is disposed, while being supported by the panel chassis 62, so as to lay over the backlight unit 82, and receives light from the backlight unit 82 (light from the backlight) so as to function as a display panel.

The backlight unit 82 includes: a plurality of fluorescent lamps (light sources) 71; a plurality of side holders (supporting frames) SF; a reflective sheet 72; a diffusive plate (diffusive member) DL; a lens sheet SS; a backlight chassis 73; and a plurality of supporting pin bases.

The florescent lamps (linear light sources) 71 each emit light, and are arranged inside the backlight unit 82 (for the sake of convenience, only part of the lamps are shown in the figure). Incidentally, a length of the fluorescent lamps 71 in a direction in which they are arranged side by side (arrangement direction) is shorter than that in a longitudinal direction. Consequently, an area defined by the plurality of fluorescent lamps 71 being so arranged side by side is rectangular. Thus, hereinafter, the arrangement of the fluorescent lamps 71 is called a rectangular arrangement. In addition, hereinafter, the arrangement direction of the fluorescent lamps 71 is called a first direction D1, and a linear direction (the longitudinal direction) of the fluorescent lamps 71 is called a second direction D2.

The side holders SF include a block BK (first block BK) supporting the plurality of fluorescent lamps 71 at one end thereof, and a block BK (first block BK) supporting the plurality of fluorescent lamps 71 at the other end thereof. That is, the side holders SF support opposite ends of the plurality of fluorescent lamps 71, respectively, so as to hold the fluorescent lamps 71.

The first block BK forming the side holder SF has a plate-like shape with its face (supporting surface 1S) facing in a same direction as a bottom portion 73a of the block backlight chassis 73 (more specifically, the reflective sheet 72 located on the bottom portion 73a of the backlight chassis 73) oriented toward the diffusive plate DL. And the diffusive plate DL is held (supported) by the supporting surfaces 1S.

The reflective sheet 72 is so disposed as to be covered by the fluorescent lamps 71 in the rectangular arrangement to thereby reflect part of light emitted in a radial manner from the fluorescent lamps 71.

The diffusive plate DL is formed of a resin such as methyl methacrylate-styrene or polycarbonate having a light scattering function and a light diffusing function, and is so located as to cover the fluorescent lamps 71 in the rectangular arrangement. Thus, the diffusive plate DL receives light from the fluorescent lamps 71 (emitted light) and light from the reflective sheet 72 (reflected light), and then scatters and diffuses that light so as to thereby expand it in an in-plane direction. Incidentally, the diffusive plate DL is made to carry heat ascribable to heat dissipated from the fluorescent lamps 71.

The lens sheet SS is a sheet having a lens-like shape, for example, inside its plane and deflecting radiation of light (converging light), and is so located as to cover the diffusive plate DL. Thus, the lens sheet SS receives the light advancing from the diffusive plate DL, and then converges it so as to thereby improve brightness of light emitted per unit area.

The backlight chassis 73 is a chassis that can accommodate the fluorescent lamps 71, reflective sheet 72, diffusive plate DL, lens sheet SS and the like. Here, there is no particular restriction imposed on the shape of the chassis.

The supporting pin base 74 is so formed as to rise from the bottom portion 73a of the backlight chassis 73. And the supporting pin base 74 permits a supporting pin 74a to project through a hole provided in the reflective sheet 72 and further to project between the fluorescent lamps 71 and 71. Thus, the supporting pin base 74 permits the supporting pin 74a to come into contact with the diffusive plate DL so located as to cover the fluorescent lamps 71, and thereby supports the diffusive plate DL. Here, there is no particular restriction imposed on the length of the supporting pin 74a.

Moreover, the supporting pin base 74 is provided with fluorescent lamp hooks 74b and 74b one on each side of a bottom end of the supporting pin 74a and grasping the fluorescent lamp 71. Thus, the supporting pin bases 74 support the diffusive plate DL with the supporting pins 74a, and firmly secure the fluorescent lamps 71 with the fluorescent lamp hooks 74b.

Next, the side holders SF will be described in detail. Although there are various kinds of materials out of which the side holders SF are made, the side holders SF of the present invention are made out of a metal. Examples of such a metal include iron and aluminum.

These metals have high thermal-conductivity compared with an acrylic resin, a polycarbonate resin, etc. For example, at a room temperature (20° C.), thermal conductivity of iron, aluminum, etc., and thermal conductivity of an acrylic resin, polycarbonate, etc. are as follows:
Iron: approximately 84 W/(m·k)
Aluminum: approximately 236 W/(m·k)
Acrylic resin: approximately 0.2 W/(m·k)
Polycarbonate: approximately 0.17 W/(m·k)

Thus, the side holders SF made out of a metal having a comparatively high thermal conductivity make contact with the diffusive plate DL. Accordingly, heat of the diffusive plate DL ascribable to the fluorescent lamps 71 is absorbed into the side holders SF. Consequently, the diffusive plate DL hardly develops a warp owing to heat. In addition, there hardly occurs nonuniformity, owing to a warp developed in the diffusive plate DL, in an amount of light emitted through the diffusive plate DL (light from the backlight).

Here, although there is no particular restriction imposed on how the side holders SF make contact with the diffusive plate DL, it preferable that they have surface-to-surface contact with each other. This is because when the side holders SF and the diffusive plate DL have surface-to-surface contact with each other, namely as an area of contact between the two is increased, heat absorption is increased.

Moreover, so that the area of contact between the side holders SF and the diffusive plate DL is increased as much as possible, the side holders SF each provided with a groove VG may be mounted as shown in FIG. 2. The grooves VG being thus formed in the side holders SF permits front and back surfaces of the diffusive plate DL to pinch in them. That is, the diffusive plate DL is held by the side holders SF each having the groove VG.

Thus, two surfaces, namely the front and back surfaces of the diffusive plate DL are made to have surface-to-surface contact with the side holders SF having high thermal-conductivity; consequently, heat carried by the diffusive plate DL is efficiently absorbed (more efficiently absorbed when compared, for example, with a case where only the back surface of the diffusive plate DL is made to have contact with the side holders SF).

### Other Embodiments

The embodiment specifically described above is not meant to limit how the present invention is practiced; various changes can be made without departing from the spirit of the prevent invention.

For example, although the foregoing deals with the backlight unit 82, in which the shorter sides of the diffusive plate DL have contact with the side holders SF, this is not meant to limit the present invention; as shown in FIG. 3, the longer sides of the diffusive plate DL may have contact with members made out of a metal (supporting surfaces 2S of supporting blocks FB) as well. That is, both shorter sides and longer sides of the diffusive plate DL may be supported by heat-absorbing members (the side holders SF and supporting blocks FB). This leads to an increase in the area of contact between the diffusive plate DL and the heat-absorbing members; consequently, heat absorption is efficiently achieved.

Moreover, as shown in FIG. 4, the grooves VG may be present in the side holders SF and the supporting blocks FB, respectively, and they permit the diffusive plate DL to be sandwiched therebetween. Thus, a large area of the front and back surfaces of the diffusive plate DL on the longer and shorter sides is made to have contact with the heat-absorbing members, and heat absorption is surely achieved.

In a case where the heat-absorbing members (side holders SF and supporting blocks FB) specifically described above hold the diffusive plate DL, the metal-made heat-absorbing members and the resin-made diffusive plate DL make contact with each other. Advantageously, such contact between materials of different nature hardly generates a sound when it is made, as compared with contact between materials of the same nature (e.g., contact between side holders made out of a resin and the diffusive plate DL made out of a resin).

1. A backlight unit having a diffusive member, through which light from a light source is passed, held by a supporting frame,
the supporting frame being made out of a metal.

2. The backlight unit according to claim 1, wherein
the metal out of which the supporting frame is made is iron or aluminum.

3. The backlight unit according to claim 1, wherein
the supporting frame and the diffusive member have surface-to-surface contact.

4. The backlight unit according to claim 1, wherein
the supporting frame is provided with a groove permitting the diffusive member to be sandwiched therebetween.

5. A liquid crystal display apparatus comprising:
the backlight unit according to claim 1; and a liquid crystal display panel receiving light from the backlight unit.
